(19) United States
(12) Patent Application Publication
(10) Pub. No.: US 2025/0045810 A1
(43) Pub. Date: Feb. 6, 2025

(54) SYSTEM AND METHOD FOR DYNAMIC PRODUCT DISAGGREGATION IN ONLINE SEARCH

(71) Applicant: Walmart Apollo, LLC, Bentonville, AR (US)

(72) Inventors: Shailesh Hiralal Jain, Palghar (IN); Praveen Reddy Suram, Bangalore (IN); Ashwinikumar Purushottam Patil, Deverabisanhalli (IN); Suravi Shome, Patna (IN); Ergin Guney, San Francisco, CA (US); Parthiban Pillai, HSR Layout (IN); Raunak Agrawal, Varthur (IN); Rudrani Ghosh, Bellandur (IN); Rahul Gupta, Fremont, CA (US); Rahul Ghosh, Karnataka (IN); Sathyam Doraswamy, HSR Layout (IN); Vaijenath Shankarrao Biradar, Marathahalli (IN); Vishakha Gupta, Langertoli (IN)

(21) Appl. No.: 18/364,993

(22) Filed: Aug. 3, 2023

(51) Int. Cl. G06Q 30/0601

(52) U.S. Cl. CPC G06Q 30/0625

(57) ABSTRACT

Systems and methods for dynamically disaggregating product variants in online search are disclosed. In some embodiments, a disclosed method includes: obtaining, from a computing device, a search request identifying a query and seeking N items to be displayed on a search result page of a website to a user, wherein N is a positive integer; determining, dynamically based on the query and N, an integer M; searching, based on the query, a database to identify M items associated with the website, wherein the M items comprise at least one subset of items that include at least one variant of a product; generating, from the M items, a ranked list of N items; and transmitting, to the computing device, the ranked list of N items in response to the search request.

### TECHNICAL FIELD

This application relates generally to online search and, more particularly, to systems and methods for dynamically disaggregating product variants on a search result page in an online search process.

### BACKGROUND

The purchase of products via online retailers has become mainstream, which has allowed customers to order an increasing number of products online and receive direct shipments of the items they order. In order to find a product to purchase, a customer typically accesses a retailer through Internet and submits a query online. Then, a search engine of the retailer may return a search result page including search results matching the query.

Many products have variants forming a product group, which is a logical grouping of variations of an anchor product, and each of the variations is called a variant. For example, a same T-shirt may have different variants each with a different color; a same TV model may have different variants each with a different screen size; a same book may have different variants each with a different format; a same mattress may have different variants each with a different size; a same packet of chips may have different variants each with a different flavor; etc. Today, a customer can only see one variant from a product group on a search result page, which reduces the discoverability of other variants in the product group. As such, customers are unable to see enough products relevant to their purchase intent. Although a product page will include all variants of a corresponding product, in many cases, customers will abandon their search, once a desired variant is not presented near the top of the search results or on a first page of the search results on the search result page.

### SUMMARY

The embodiments described herein are directed to systems and methods for dynamically disaggregating product variants on a search result page in an online search process.

In various embodiments, a system including a non-transitory memory configured to store instructions thereon and at least one processor is disclosed. The at least one processor is configured to read the instructions to: obtain, from a computing device, a search request identifying a query and seeking N items to be displayed on a search result page of a website to a user, wherein N is a positive integer; determine, dynamically based on the query and N, an integer M; search, based on the query, a database to identify M items associated with the website, wherein the M items comprise at least one subset of items that include at least one variant of a product; generate, from the M items, a ranked list of N items, and transmit, to the computing device, the ranked list of N items in response to the search request.

In various embodiments, a computer-implemented method is disclosed. The computer-implemented method includes: obtaining, from a computing device, a search request identifying a query and seeking N items to be displayed on a search result page of a website to a user, wherein N is a positive integer; determining, dynamically based on the query and N, an integer M; searching, based on the query, a database to identify M items associated with the website, wherein the M items comprise at least one subset of items that include at least one variant of a product; generating, from the M items, a ranked list of N items; and transmitting, to the computing device, the ranked list of N items in response to the search request.

In various embodiments, a non-transitory computer readable medium having instructions stored thereon is disclosed. The instructions, when executed by at least one processor, cause at least one device to perform operations including: obtaining, from a computing device, a search request identifying a query and seeking N items to be displayed on a search result page of a website to a user, wherein N is a positive integer; determining, dynamically based on the query and N, an integer M; searching, based on the query, a database to identify M items associated with the website, wherein the M items comprise at least one subset of items that include at least one variant of a product; generating, from the M items, a ranked list of N items; and transmitting, to the computing device, the ranked list of N items in response to the search request.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide search results including dynamically disaggregated product variants, in accordance with some embodiments of the present teaching.

FIG. 2 is a block diagram of a search-based recommendation computing device, in accordance with some embodiments of the present teaching.

FIG. 3 is a block diagram illustrating various portions of a search-based item recommendation system, in accordance with some embodiments of the present teaching.

FIG. 4 illustrates a first exemplary search result page including disaggregated product variants, in accordance with some embodiments of the present teaching.

FIG. 5 illustrates a second exemplary search result page including disaggregated product variants, in accordance with some embodiments of the present teaching.

FIG. 6 illustrates a third exemplary search result page including disaggregated product variants, in accordance with some embodiments of the present teaching.

FIG. 7 illustrates an exemplary product page shown after a user clicks on an item in a search result page, in accordance with some embodiments of the present teaching.

FIG. 8 shows an exemplary block diagram illustrating a more detailed view of a search-based recommendation computing device, in accordance with some embodiments of the present teaching.

FIG. 9 illustrates an exemplary item recall process, in accordance with some embodiments of the present teaching.

FIG. 10 illustrates exemplary aggregation levels in search results, in accordance with some embodiments of the present teaching.

FIG. 11 illustrates a first user case of a search-based item recommendation system, in accordance with some embodiments of the present teaching.

FIG. 12 illustrates a second user case of a search-based item recommendation system, in accordance with some embodiments of the present teaching.

FIG. 13 illustrates a third user case of a search-based item recommendation system, in accordance with some embodiments of the present teaching.

FIG. 14 is a flowchart illustrating an exemplary method for providing search results including dynamically disaggregated product variants, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

If a search result page always shows one variant in each product group having multiple variants, a customer may miss out deals or popular items as it takes a long time for the customer to dig into product pages from tons of search results on the search result page. There are many challenges to show product variants in search results. For example, product variants can lead to content duplication, meaning similar content may appear on the same search result page. Content duplication may harm shopping experience if not treated carefully. In addition, product variants in a product group selected as search results should match the customer intent, but at the same time be different from the product group itself, to avoid confusing the customer. Whether, when and how to aggregate or disaggregate the similar and duplicate variants can be quite challenging, which may need appropriate demotion and relative distance maintained to control the aggregation behavior.

One goal of various embodiments in the present teaching is to provide search results including dynamically disaggregated product variants. In some embodiments, after receiving a query from a customer, a disclosed system can dynamically identify how many items or variants from a product group should be shown to the customer, e.g. based on multiple shopping contextual factors using a trained machine learning model. For example, for a deal seeking customer, the system can show more deal variants from a same product group that are relevant to the customer's search intent. For an electronics buying journey, the system can show more popular models and newer models that are variants of a product group. For a grocery shopper, the system can show personalized search results including previously purchased variants.

In some embodiments, all variants are brought into the primary index of a product database to make them discoverable and searchable directly based on a query. The system can select one or more variants that match the customer's intent to perform a dynamic product grouping. In some embodiments, the system can support different aggregation levels for a product having variants, including for example: a high aggregation where all variants of the product are aggregated into a single result when being displayed on a search result page, a low aggregation where each variant of the product is displayed as a separate result on the search result page; and a medium aggregation where variants of the product are aggregated into multiple sub-groups each of which is displayed as a separate result on the search result page. In some embodiments, the system can determine an aggregation level in real-time for each product to be presented on a search result page, e.g. based on query, category, business logic, product type, customer intent, customer's device (e.g. desktop, smartphone or tablet), etc.

In some embodiments, the system can utilize some variant-level signals, e.g. variant-level item popularity, variant-level size signal, variant-level engagement, variant-level title and description, etc., to improve discoverability, filtering and/or ranking of variants. A machine learning model may be trained to ensure relevance of variants to the query.

The disclosed system can improve discoverability of product offers or deals at the variant level, e.g. through some variant level signals, to give users capability to view or add-to-cart the offered items at variant level. Further, the disclosed method and system can be applied to any online shopping journey, to improve key category experiences, improve discoverability of good marketplace product variants, improve visibility of new products or variants with low engagement, and personalize customer's experience e.g. by showing previously purchased variants to the customer.

Furthermore, in the following, various embodiments are described with respect to methods and systems for dynamically disaggregating product variants in online search. In some embodiments, a disclosed method includes: obtaining, from a computing device, a search request identifying a query and seeking N items to be displayed on a search result page of a website to a user, wherein N is a positive integer; determining, dynamically based on the query and N, an integer M; searching, based on the query, a database to identify M items associated with the website, wherein the M items comprise at least one subset of items that include at least one variant of a product; generating, from the M items, a ranked list of N items; and transmitting, to the computing device, the ranked list of N items in response to the search request.

In the present disclosure, “product group” and “group product” are used interchangeably to represent a product having a group of variants. In contrast, “regular product” is used to represent a product having no variant or variation.

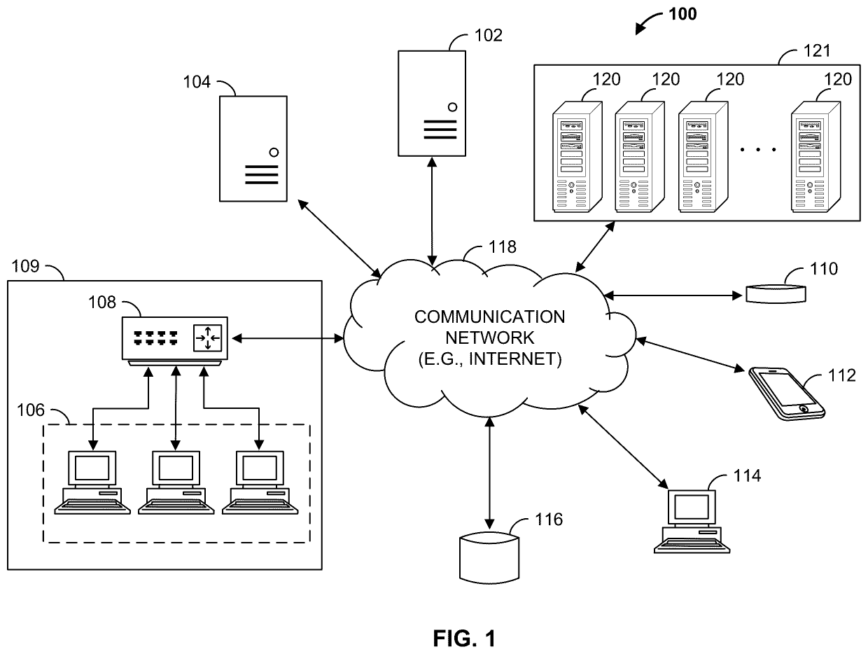

Turning to the drawings, FIG. 1 is a network environment 100 configured to provide search results including dynamically disaggregated product variants, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a search-based recommendation computing device 102 (e.g., a server, such as an application server), a web server 104, a cloud-based engine 121 including one or more processing devices 120, workstation(s) 106, a database 116, and one or more customer computing devices 110, 112, 114 operatively coupled over the network 118. The search-based recommendation computing device 102, the web server 104, the workstation(s) 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the search-based recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the search-based recommendation computing device 102.

In some examples, each of the multiple customer computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites. In some examples, the search-based recommendation computing device 102, the processing devices 120, and/or the web server 104 are operated by a retailer, and the multiple customer computing devices 110, 112, 114 are operated by customers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109, for example. The workstation(s) 106 can communicate with the search-based recommendation computing device 102 over the communication network 118. The workstation(s) 106 may send data to, and receive data from, the search-based recommendation computing device 102. For example, the workstation(s) 106 may transmit data identifying items purchased by a customer at the store 109 to search-based recommendation computing device 102.

Although FIG. 1 illustrates three customer computing devices 110, 112, 114, the network environment 100 can include any number of customer computing devices 110, 112, 114. Similarly, the network environment 100 can include any number of the search-based recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the first customer computing device 110, the second customer computing device 112, and the Nth customer computing device 114 may communicate with the web server 104 over the communication network 118. For example, each of the multiple computing devices 110, 112, 114 may be operable to view, access, and interact with a website, such as a retailer's website, hosted by the web server 104. The web server 104 may transmit user session data related to a customer's activity (e.g., interactions) on the website. For example, a customer may operate one of the customer computing devices 110, 112, 114 to initiate a web browser that is directed to the website hosted by the web server 104. The customer may, via the web browser, search for items, view item advertisements for items displayed on the website, and click on item advertisements and/or items in the search result, for example. The website may capture these activities as user session data, and transmit the user session data to the search-based recommendation computing device 102 over the communication network 118. The website may also allow the operator to add one or more of the items to an online shopping cart, and allow the customer to perform a “checkout” of the shopping cart to purchase the items. In some examples, the web server 104 transmits purchase data identifying items the customer has purchased from the website to the search-based recommendation computing device 102.

In some examples, the search-based recommendation computing device 102 may execute one or more models (e.g., algorithms), such as a machine learning model, deep learning model, statistical model, etc., to determine recommended items to advertise to the customer (i.e., item recommendations). The search-based recommendation computing device 102 may transmit the item recommendations to the web server 104 over the communication network 118, and the web server 104 may display one or more of the recommended items on the website to the customer. For example, the web server 104 may display the recommended items to the customer on a homepage, a catalog webpage, an item webpage, a window or interface of a chatbot, a search results webpage, or a post-transaction webpage of the website (e.g., as the customer browses those respective webpages).

In some examples, the web server 104 transmits a recommendation request to the search-based recommendation computing device 102. The recommendation request may be a search request sent together with a search query provided by the customer (e.g., via a search bar of the web browser, or via a conversational interface of chatbot), or a standalone recommendation request provided by a processing unit in response to the user's action on the website, e.g. interacting (e.g., engaging, clicking, or viewing) with one or more items, adding one or more items to cart, purchasing one or more items, opening or refreshing a homepage.

In some examples, a customer submits a query on a website hosted by the web server 104. The web server 104 may send a search request to the search-based recommendation computing device 102. In response to receiving the search request, the search-based recommendation computing device 102 may execute the one or more processors to determine search results including items matching the first query, and transmit the search results including recommended items to the web server 104 to be displayed to the customer. The recommended items may be at the variant level, which means when a product have multiple variants each with a different feature (e.g. different colors, different sizes, etc.), the search-based recommendation computing device 102 may recommend one or more variants of a same product to be displayed together on a search result page.

The search-based recommendation computing device 102 is further operable to communicate with the database 116 over the communication network 118. For example, the search-based recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the search-based recommendation computing device 102, in some examples, the database 116 can be a local storage device, such as a hard drive, a non-volatile memory, or a USB stick. The search-based recommendation computing device 102 may store purchase data received from the web server 104 in the database 116. The search-based recommendation computing device 102 may also receive from the web server 104 user session data identifying events associated with browsing sessions, and may store the user session data in the database 116.

In some examples, the search-based recommendation computing device 102 generates training data for a plurality of models (e.g., machine learning models, deep learning models, statistical models, algorithms, etc.) based on aggregation data, variant-level data, holiday and event data, recall data, historical user session data, search data, purchase data, catalog data, and/or advertisement data for the users. The search-based recommendation computing device 102 trains the models based on their corresponding training data, and the search-based recommendation computing device 102 stores the models in a database, such as in the database 116 (e.g., a cloud storage).

The models, when executed by the search-based recommendation computing device 102, allow the search-based recommendation computing device 102 to determine item recommendations to be displayed to a customer. For example, the search-based recommendation computing device 102 may obtain the models from the database 116. The search-based recommendation computing device 102 may then receive, in real-time from the web server 104, a search request identifying a query and seeking N items to be displayed on a search result page of the website to a user. In response to receiving the search request, the search-based recommendation computing device 102 may execute the models to determine recommended items at variant level to display to the customer.

In some examples, the search-based recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, search-based recommendation computing device 102 may generate ranked item recommendations for items and variants to be displayed on the website to a user.

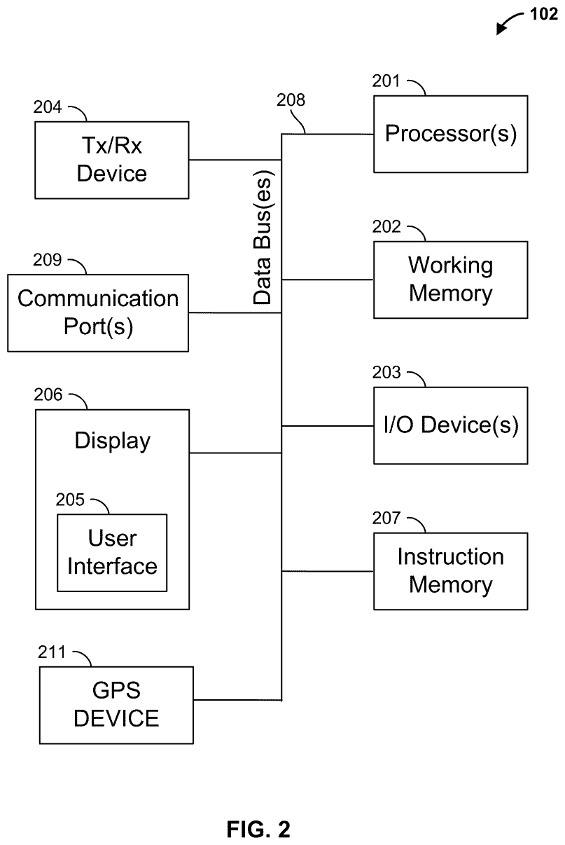

FIG. 2 illustrates a block diagram of a search-based recommendation computing device, e.g. the search-based recommendation computing device 102 of FIG. 1, in accordance with some embodiments of the present teaching. In some embodiments, each of the search-based recommendation computing device 102, the web server 104, the workstation(s) 106, the multiple customer computing devices 110, 112, 114, and the one or more processing devices 120 in FIG. 1 may include the features shown in FIG. 2. Although FIG. 2 is described with respect to the search-based recommendation computing device 102. It should be appreciated, however, that the elements described can be included, as applicable, in any of the search-based recommendation computing device 102, the web server 104, the workstation(s) 106, the multiple customer computing devices 110, 112, 114, and the one or more processing devices 120.

As shown in FIG. 2, the search-based recommendation computing device 102 can include one or more processors 201, a working memory 202, one or more input/output devices 203, an instruction memory 207, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the search-based recommendation computing device 102. The working memory 202 can be a random access memory (RAM) such as a static random access memory (SRAM) or dynamic random access memory (DRAM), or any other suitable memory.

The input-output devices 203 can include any suitable device that allows for data input or output. For example, the input-output devices 203 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the search-based recommendation computing device 102. For example, the user interface 205 can be a user interface for an application of a retailer that allows a customer to view and interact with a retailer's website. In some examples, a user can interact with the user interface 205 by engaging the input-output devices 203. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the search-based recommendation computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the search-based recommendation computing device 102 may determine a local geographical area (e.g., town, city, state, etc.) of its position. Based on the geographical area, the search-based recommendation computing device 102 may determine relevant trend data (e.g., trend data identifying events in the geographical area).

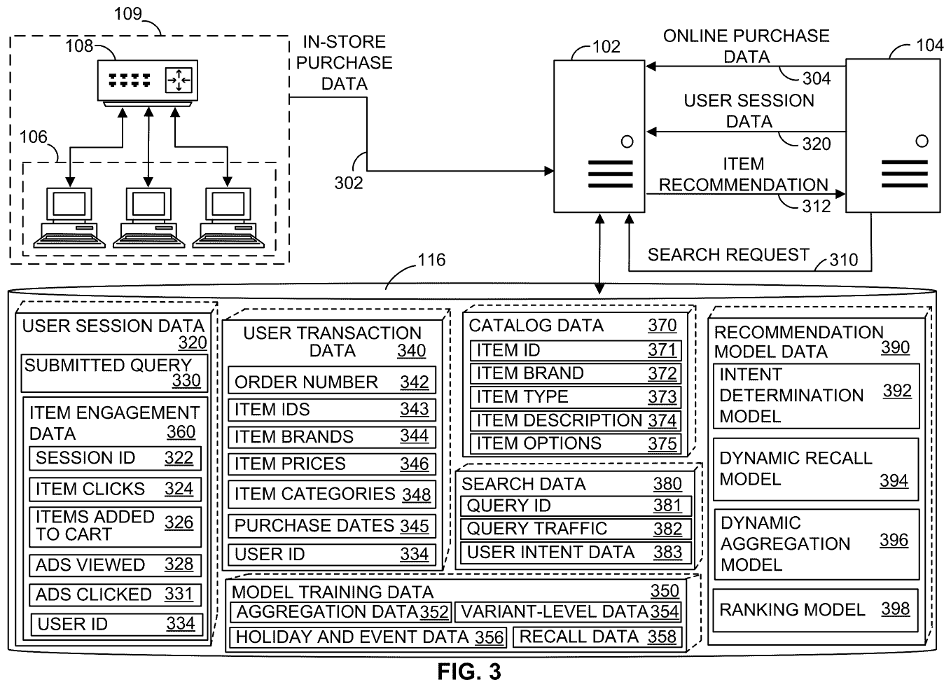

FIG. 3 is a block diagram illustrating various portions of a search-based item recommendation system, e.g. the search-based item recommendation system shown in the network environment 100 of FIG. 1, in accordance with some embodiments of the present teaching. As indicated in FIG. 3, the search-based recommendation computing device 102 may receive user session data 320 from the web server 104, and store the user session data 320 in the database 116. The user session data 320 may identify, for each user (e.g., customer), data related to that user's browsing session, such as when browsing a retailer's webpage hosted by the web server 104.

In some examples, the user session data 320 may include item engagement data 360 and/or submitted query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.).

The submitted query data 330 may identify one or more searches conducted by a user during a browsing session (e.g., a current browsing session). For example, the search-based recommendation computing device 102 may receive a search request 310 from the web server 104. The search-based recommendation computing device 102 may store the search terms provided by the user as submitted query data 330.

The search-based recommendation computing device 102 may also receive online purchase data 304 from the web server 104, which identifies and characterizes one or more online purchases, such as purchases made by the user and other users via a retailer's website hosted by the web server 104. The search-based recommendation computing device 102 may also receive in-store purchase data 302 from the store 109, which identifies and characterizes one or more in-store purchases. In some embodiments, the in-store purchase data 302 may also indicate availability of items in the store 109, and/or user IDs that have selected the store 109 as a default store for picking up online orders.

The search-based recommendation computing device 102 may parse the in-store purchase data 302 and the online purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item categories 348 identifying a category of each item purchased, a purchase date 345 identifying the purchase date of the purchase order, and user ID 334 for the user making the corresponding purchase.

The database 116 may further store catalog data 370, which may identify one or more features or attributes of a plurality of items, such as a portion of or all items a retailer carries. The catalog data 370 may identify, for each of the plurality of items, an item ID 371 (e.g., an SKU number), item brand 372, item type 373 (e.g., a product type like grocery item such as milk, clothing item), item description 374 (e.g., a description of the product including product features, such as ingredients, benefits, use or consumption instructions, or any other suitable description), and item options 375 (e.g., item colors, sizes, flavors, etc.). In some embodiments, a variant of a product can be determined based on a corresponding item ID 371 and one or more corresponding item options 375.

The database 116 may also store search data 380, which may identify one or more features of a plurality of queries submitted by users on the website. The search data 380 may include, for each of the plurality of queries, a query ID 381 identifying a query previously submitted by users, query traffic data 382 identifying how many times the query has been submitted or how many clicks the query has received, and user intent data 383 identifying user intents determined based on submitted queries.

The database 116 may also store model training data 350, which may identify various data generated for training a model to be used for item recommendation on the website during a training stage, and for determining recommended items or variants during an inference stage. The model training data 350 may include: aggregation data 352 identifying aggregation levels and manners associated with products or categories, variant-level data 354 identifying data specific to some variants of a product, holiday and event data 356 identifying deals, special offers and other data related to holidays and events, and recall data 358 identifying recall numbers in response to different queries based on category and user intent.

The database 116 may also store recommendation model data 390 identifying and characterizing one or more models (e.g. machine learning models) and related data. For example, the recommendation model data 390 may include an intent determination model 392, a dynamic recall model 394, a dynamic aggregation model 396, and a ranking model 398. The intent determination model 392 may be used to determine an intent of the user, e.g. based on a query submitted by the user. For example, the intent determination model 392 may be a machine learning model trained based on a natural language processing algorithm, historical search data and historical transaction data.

The dynamic recall model 394 may be used to determine the optimal number of items to be fetched and aggregated in real time given a query. The optimal number here refers to a quantity of items fetched at variant level, i.e. a total number of variants (of group products) and regular products fetched, given the query. The optimal number may be dynamically determined based on the query, category and user intent. The dynamic recall model 394 may be a machine learning model that is trained periodically based on historical search data and historical transaction data associated with the website. For example, the dynamic recall model 394 may be re-trained every day, every week, every month, or every year, based on latest data.

In some embodiments, the dynamic recall model 394 may be trained based on historical recall data 358 and/or holiday and event data 356. For example, the optimal number of items to be fetched given a query may depend on historical recall numbers and historical transactions performed in response to those recall numbers. In addition, the optimal number of items to be fetched given a query may also depend on whether the query is submitted during a holiday or event. For example, during a Thanksgiving shopping season, more variants with discounts and deals may be fetched for a given query. In some embodiments, the optimal number generated by the dynamic recall model 394 may be stored in the recall data 358, for future model training or data inference.

In some embodiments, the dynamic aggregation model 396 may be used to determine an aggregation level for a group product having variants, when the group product is fetched or retrieved given a query. The aggregation level may be determined to be one of: a high aggregation where all variants of the group product are aggregated into a single result when being displayed on a search result page; a low aggregation where each variant of the group product is displayed as a separate result on the search result page; or a medium aggregation where variants of the group product are aggregated into multiple sub-groups each of which is displayed as a separate result on the search result page. In some embodiments, there may be more or less than three aggregation levels in total for a group product.

In some embodiments, the dynamic aggregation model 396 may be a machine learning model trained based on historical aggregation data 352 and historical search and transaction data. The trained dynamic aggregation model 396 may be utilized to determine an aggregation level for each group product matching a given query, based on the category of the group product and the user intent associated with the query. In some embodiments, the aggregation level determined by the dynamic aggregation model 396 may be stored in the historical aggregation data 352, for future model training or data inference.

In some embodiments, the ranking model 398 may be used to rank a plurality of items (including variants and regular products) to generate a ranked list of recommended items to be displayed to the user, given a query. For example, the ranking model 398 may be a machine learning model trained based on historical variant-level data, historical search data and historical transaction data associated with the website. The ranking model 398 may be utilized to rank items fetched given the query, based on their respective matching scores and some variant-level data 354 associated with each variant in the items. A matching score may indicate a matching degree between a corresponding item and the query. The variant-level data 354 for each variant may include: a variant-level popularity score representing a popularity of the variant, a variant-level relevance score representing a relevance of the variant to the query, and/or a variant-level engagement score representing users' engagement with the variant. In some examples, the popularity of the variant may be a function of revenue of the variant within a given time period. In some embodiments, one or more of the intent determination model 392, the dynamic recall model 394, the dynamic aggregation model 396, and the ranking model 398 are machine learning models (e.g. deep learning models, neural networks) that are pre-trained before being stored in the database 116. For example, during a training stage of the system, a list of query-item pairs are generated based on queries submitted by users during a past time period and corresponding variant level items purchased by the users. The list of query-item pairs from the past time period is used to train the machine learning models in the recommendation model data 390, and the trained machine learning models can be applied for a future time period.

In some examples, the search-based recommendation computing device 102 receives (e.g., in real-time), from the web server 104, a search request 310 identifying a query and seeking N items to be displayed to a user on a search result page of a website hosted by the web server 104. In response, the search-based recommendation computing device 102 generates item recommendation 312 identifying recommended items in response to the query, and transmits the item recommendation 312 to the web server 104. In some examples, the recommended items include different variants of a group product, as well as some regular products. That is, the recommended items are identified at variant level, and selected from items fetched at variant level in response to the query. In some embodiments, based on the query, the search-based recommendation computing device 102 determine a dynamic number as a total quantity of the items fetched at variant level in response to the query.

In some embodiments, the search-based recommendation computing device 102 may assign one or more of the above described operations to a different processing unit or virtual machine hosted by the one or more processing devices 120. Further, the search-based recommendation computing device 102 may obtain the outputs of the these assigned operations from the processing units, and generate the item recommendation 312 based on the outputs.

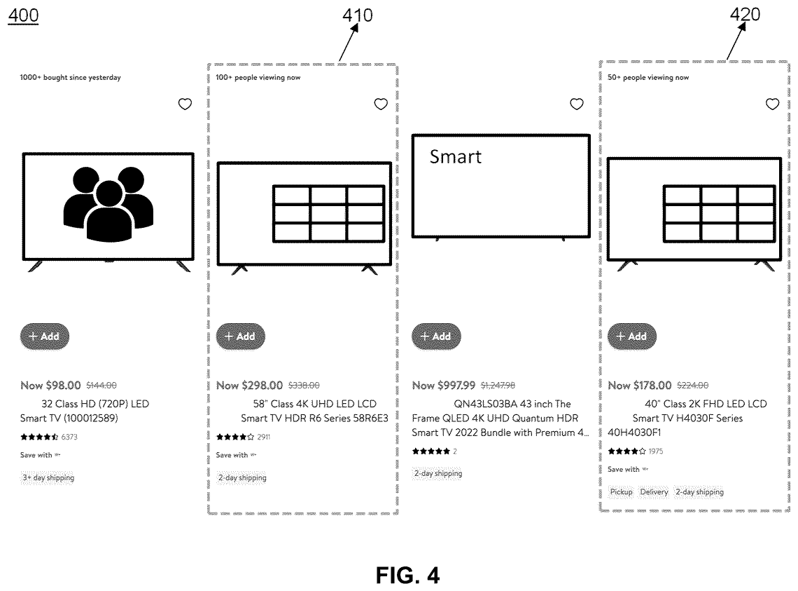

FIG. 4 illustrates a first exemplary search result page 400 including disaggregated product variants, in accordance with some embodiments of the present teaching. As shown in FIG. 4, the search result page 400 includes search results including variants 410, 420 in a same product group of smart TV, given a query indicating that a user wants a smart TV. In this example, because both variants 410, 420 in the product group of smart TV have deals, they are both selected and disaggregated to be displayed separately in the search results. As such, a user can directly view these variants 410, 420 with deals or during deal events on the search result page 400, without a need to go to the corresponding product page.

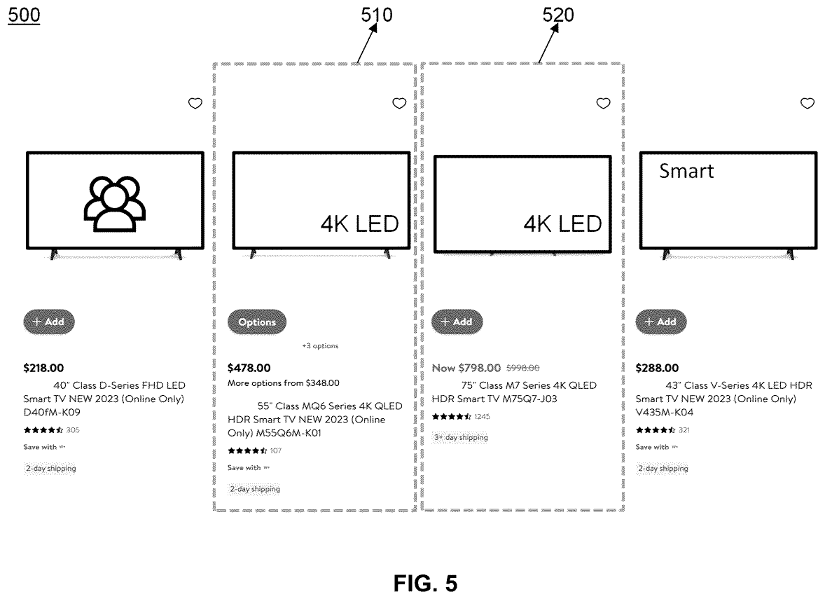

FIG. 5 illustrates a second exemplary search result page 500 including disaggregated product variants, in accordance with some embodiments of the present teaching. As shown in FIG. 5, the search result page 500 includes search results including variants 510, 520 in a same product group of smart TV, given a query indicating that a user wants a smart TV. In this example, because both variants 510, 520 in the product group of smart TV are popular items, they are both selected and disaggregated to be displayed separately in the search results. As such, a user can directly view these variants 510, 520 that are popular and relevant items on the search result page 500, without a need to go to the corresponding product page. In some embodiments, the variant 510 is separately displayed because it is popular; and the variant 520 is separately displayed because it is popular and/or has an on-going deal.

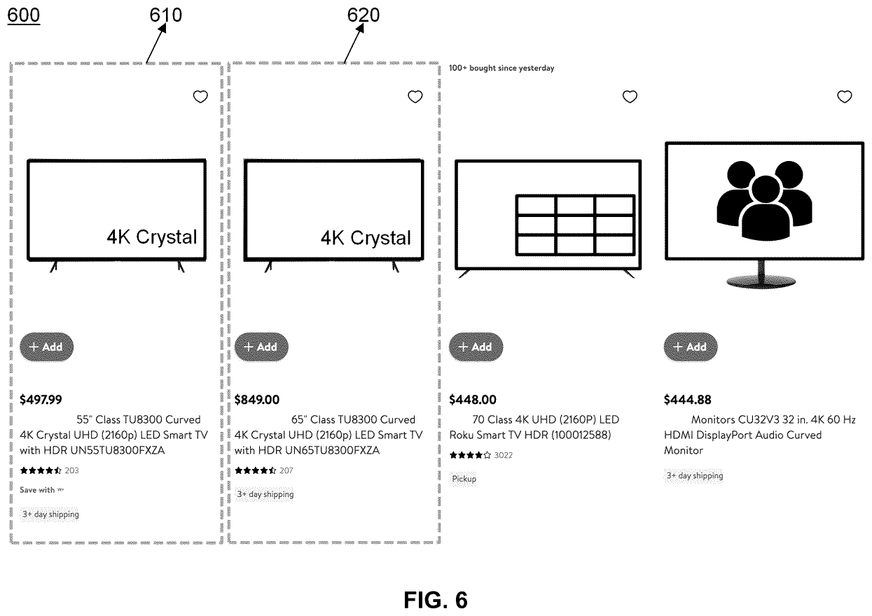

FIG. 6 illustrates a third exemplary search result page 600 including disaggregated product variants, in accordance with some embodiments of the present teaching. As shown in FIG. 6, the search result page 600 includes search results including variants 610, 620 in a same product group of smart TV, given a query indicating that a user wants a smart TV. In this example, because both variants 610, 620 in the product group of smart TV are new models (curved TV models) launched in the market, they are both selected and disaggregated to be displayed separately in the search results. As such, a user can directly view these variants 610, 620 that are new models on the search result page 600, without a need to go to the corresponding product page.

As shown in FIGS. 4-6, disaggregating variants of a same product group in search results can help a user to discover more good deals, more popular items, new models, and/or new brands. In addition, disaggregated variants can inform the user about all of the available features of a same group product, e.g. all screen sizes, all resolutions, etc. This can improve the basket building for a user, as the user can easily find relevant items right away in the search results and keep adding to cart the desired variant, without a need to click and go to detailed product page.

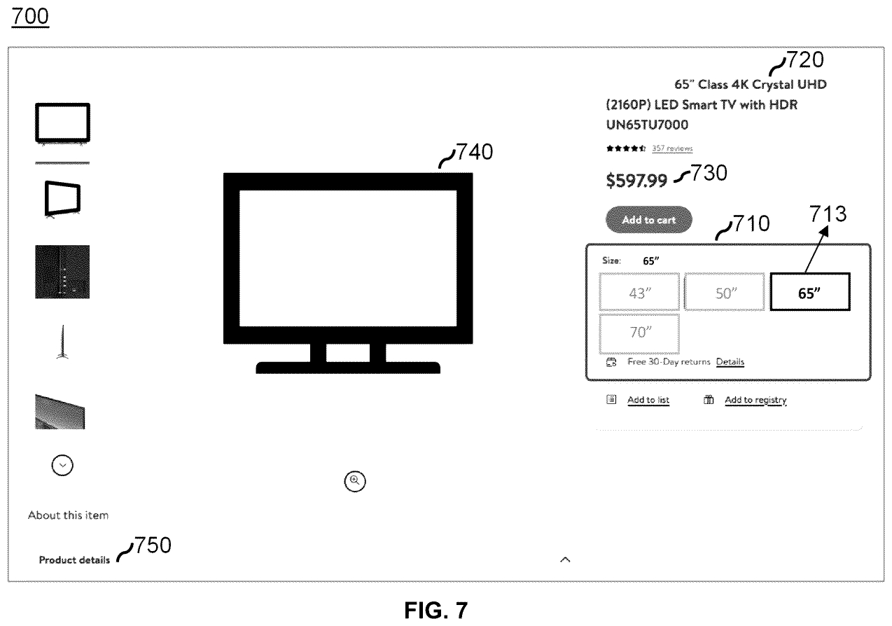

In view of the search results shown in FIGS. 4-6, if a user clicks on any variant, the user will be directed to a logically grouped item page or product page. FIG. 7 illustrates an exemplary product page 700 shown after a user clicks on an item in a search result page, e.g. one of the search result pages 400, 500, 600 shown in FIGS. 4-6, in accordance with some embodiments of the present teaching. The product page 700 shows detailed information about a group product, which is an LED smart TV in this example. The group product includes multiple variants each having a different screen size, e.g. 43″, 50″, 65″, 70″. After a user clicks on any one of the variants shown on a search result page, the user will be led to this product page 700.

As shown in FIG. 7, the product page 700 includes an item option section 710 showing all variants of the smart TV. In some examples, because the user is led to the product page 700 after the user clicks on the variant of 65″ 713, the variant of 65″ 713 (rather than other variants) is directly highlighted in the item option section 710 when the product page 700 is displayed to the user. Accordingly, other sections shown in the product page 700, including the title 720, the price 730, the images 740, the product detail description 750, are also consistent with the variant of 65″ 713, (rather than other variants).

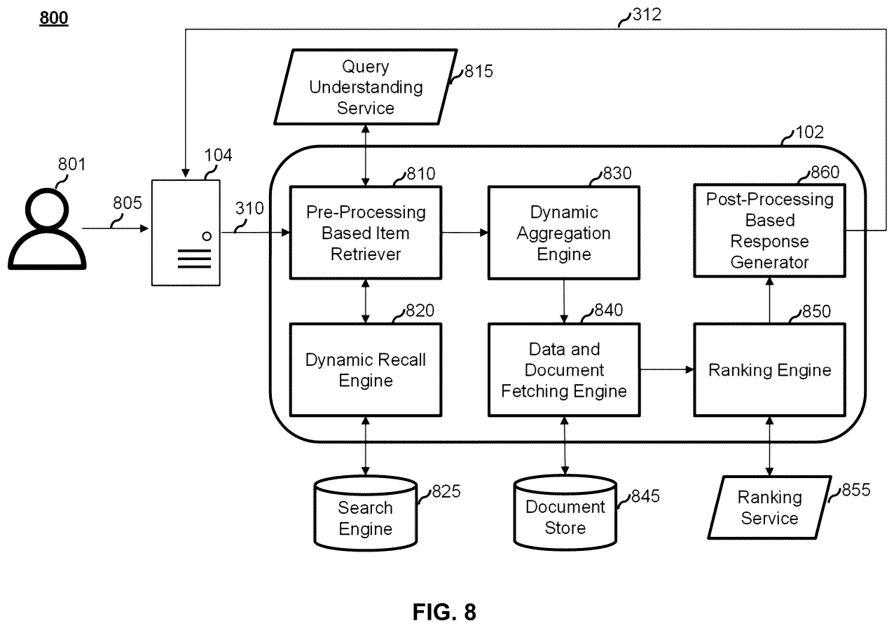

FIG. 8 shows an exemplary block diagram illustrating a more detailed view of a search-based recommendation computing device, e.g. the search-based recommendation computing device 102 in FIG. 1, in accordance with some embodiments of the present teaching. As shown in FIG. 8, the search-based recommendation computing device 102 includes a pre-processing based item retriever 810, a dynamic recall engine 820, a dynamic aggregation engine 830, a data and document fetching engine 840, a ranking engine 850, and a post-processing based response generator 860. In some examples, one or more of the pre-processing based item retriever 810, the dynamic recall engine 820, the dynamic aggregation engine 830, the data and document fetching engine 840, the ranking engine 850, and the post-processing based response generator 860 are implemented in hardware. In some examples, one or more of the pre-processing based item retriever 810, the dynamic recall engine 820, the dynamic aggregation engine 830, the data and document fetching engine 840, the ranking engine 850, and the post-processing based response generator 860 are implemented as an executable program maintained in a tangible, non-transitory memory, such as instruction memory 207 of FIG. 2, which may be executed by one or processors, such as the processor 201 of FIG. 2.

For example, the pre-processing based item retriever 810 may obtain from the web server 104 a search request 310 as a message 805 is sent from a user 801 to the web server 104. The message 805 may be sent by the user 801 using a user device, e.g. one of the customer computing devices 110, 112, 114, and may indicate a search query submitted by the user via the user device. In some embodiments, the search request 310 is to seek one or more recommended items to be displayed to the user on a search result page of a website hosted by the web server 104. In some embodiments, the query may include texts input by the user in a search bar. In some embodiments, the query may include texts converted from an utterance input by the user.

In this example, the web server 104 transmits a search request 310 to the search-based recommendation computing device 102. The search request 310 may identify a number N of items to be displayed on the search result page, in response to the query. The number N is a positive integer, which may be determined by the web server 104 based on e.g. a screen size of the user device, a type of the user device, etc. In some examples, the search request 310 further identifies a user (e.g., customer) for whom the item recommendations are requested at the web server 104.

In some embodiments, the pre-processing based item retriever 810 may receive and parse the search request 310, to determine the query and the number N. Based on the query, the pre-processing based item retriever 810 can determine a category and/or an intent of the user. For example, the pre-processing based item retriever 810 may send a service request to a query understanding service 815 to generate an understanding of the query, e.g. using some natural language processing algorithm. In some examples, the natural language processing algorithm may be applied based on a language used in the query, previous queries submitted by the user, a time period or shopping season when the query is submitted, and/or other data related to the query. While the query understanding service 815 in FIG. 8 is outside the search-based recommendation computing device 102, the query understanding service 815 may be included as part of the search-based recommendation computing device 102 in some embodiments. The query understanding service 815 can send the understanding of the query to the pre-processing based item retriever 810. Based on the understanding, the pre-processing based item retriever 810 can determine a category of products related to the query, and/or an intent of the user submitting the query, e.g. based on the intent determination model 392 in the database 116.

In some embodiments, the pre-processing based item retriever 810 may retrieve items based on the query, through the dynamic recall engine 820, which can determine, dynamically based on the query and N, an integer M that is larger than N. For example, when N=128, M may be a number 5˜20 times larger than N. This integer M represents the optimal number of items that should be fetched or retrieved to select the N items, from the M fetched items, for recommendation to the user. In some embodiments, the pre-processing based item retriever 810 may send information related to the query, including the category, the user intent, the number N, and/or the query itself, to the dynamic recall engine 820. Based on the received information, the dynamic recall engine 820 may determine the integer M using a machine learning model, e.g. the dynamic recall model 394 in the database 116.

In some embodiments, the machine learning model is trained periodically, e.g. daily, weekly, or monthly, based on the model training data 350, which may be generated based on historical search data and historical transaction data associated with the website. For example, the machine learning model may be re-trained every week using the recall data 358 and/or the variant-level data 354 from last week. Based on the trained machine learning model, the dynamic recall engine 820 can determine the dynamic number M, which indicate a total quantity of items to be fetched at the variant level. That is, the dynamic recall engine 820 will recall M items associated with the website from a database 825 based on the query, where each item of the M items is either a regular product without variants, or a variant of a group product that has a plurality of variants. In some embodiments, the M items comprise a plurality of variants of a same group product.

In some embodiments, the database 825 may be associated with or managed by a search engine that is either outside the search-based recommendation computing device 102 as shown in FIG. 8 or included as part of the search-based recommendation computing device 102 in some embodiments. The database 825 may be part of the database 116 or a standalone database. In some examples, each variant in the database 825 is indexed as an individual searchable item; and each regular product in the database 825 is indexed as an individual searchable item. For example, there is a variant inclusion identifier in the database 825 to make each variant individually searchable.

In some embodiments, the dynamic recall engine 820 may search the database 825, e.g. through the search engine, to identify the M items based on the query. In some example, for each variant in the database 825, the dynamic recall engine 820 can compute, based on historical data, a variant-level popularity score representing a popularity of the variant. In addition, for each variant in the database 825, the dynamic recall engine 820 can compute, based on the query, a variant-level relevance score representing a relevance of the variant to the query. The dynamic recall engine 820 can compute a matching score for each variant in the database 825 based on the variant-level popularity score and the variant-level relevance score, and identify the M items based on their respective matching scores. In some examples, the matching score may be a combination (e.g. summation, weighted summation, or any other combination) of the variant-level popularity score and the variant-level relevance score. In some examples, the matching score may be computed also based on other data including the holiday and event data 356, and/or data related to the user, e.g. previously queries submitted by the user, previously variants purchased by the user, etc. In some examples, the matching score may be used by the dynamic recall engine 820 as a relevance guardrail for filtering out the variants and/or regular products whose matching scores are lower than a predetermined threshold.

In some embodiments, the pre-processing based item retriever 810 may extract and parse the user session data 320 (e.g., user session data associated with a current user session of the user in real-time) from the database 116; and may also extract the user transaction data 340, the search data 380, and/or the model training data 350 from the database 116. In some embodiments, the dynamic recall engine 820 can obtain or collect various data with respect to the search request 310, either from the pre-processing based item retriever 810 or directly from the database 116.

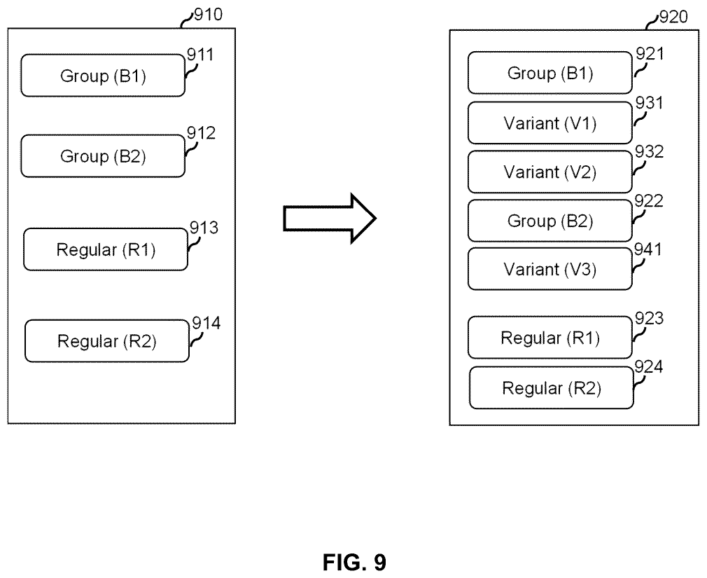

FIG. 9 illustrates an exemplary item recall process, in accordance with some embodiments of the present teaching. As shown in FIG. 9, after identifying a product group based on a query, e.g. Group (B1) 911 that has multiple variants, a normal recall process 910 would just recall a group leader from the product group 911, without recalling other variants of the same product group. The group leader may be one variant of the product group and may be predetermined by the seller. Similarly, the normal recall process 910 just recalls a group leader from the product group 912, without recalling other variants of the same product group. In addition, the normal recall process 910 may recall some regular products 913, 914 based on the query.

In contrast, a dynamic item recall process 920, which may be performed by the dynamic recall engine 820 in FIG. 8, would recall, based on a query, not only a group leader of a product group, e.g. Group (B1) 921, but also some other variants of the same product group, e.g. Variant (V1) 931 and Variant (V2) 932. Similarly, the dynamic item recall process 920 recall, based on the query, not only a group leader of the product group, Group (B2) 922, but also some other variant of the same product group, e.g. Variant (V3) 941. In addition, the dynamic item recall process 920 may also recall some regular products 923, 924 based on the query. In some embodiments, the total number of items, including regular products and variants of group products, recalled by the dynamic item recall process 920 is equal to the dynamic number M determined by the dynamic recall engine 820.

In some embodiments, there may be more or less than three levels of aggregation in total. In some embodiments, the system can dynamically determine whether to aggregate or disaggregate a group product; and dynamically determine an aggregation level for the group product, in real time based on various factors and customer's changing needs. In some embodiments, a dynamic aggregation or disaggregation is performed regarding a product based on various factors in response to a query submitted by a user, including but not limited to: deals or clearance or rollback or rewards available to the product, total quantity of variants of the product, specificity of the user's intent, the user's unique preferences, some category specific journeys, whether inventory of the product is low, and whether the product has a high CP.

In some embodiments, for a group product in a non-routine or non-grocery category, a dynamic aggregation or disaggregation is performed in response to a query submitted by a user based on various factors including but not limited to: whether the user is a deal seeker, whether the query is submitted on a special shopping season or during a deal event, whether the user intent is narrow, whether the recall number is low, price affinity of the product, previously viewed product or variant of the user, user cohort specific products of interest, new models of the product, popular variants of the product, whether the product is popular and fast moving, whether the product has high OLQ, and whether product has a high one demand signal.

In some embodiments, for a group product in a routine or grocery category, a dynamic aggregation or disaggregation is performed in response to a query submitted by a user based on various factors including but not limited to: whether the product has low to medium HHI, whether the user intent is narrow, whether the recall number is low, previously purchased product or variant of the user, and whether there is a shortage of the product. In some embodiments, disaggregating a grocery product group can make it easy for the user to add to cart a corresponding variant.

Referring back to FIG. 8, in some embodiments, the dynamic recall engine 820 returns a list of item IDs and respective matching scores for the M items to the pre-processing based item retriever 810. The pre-processing based item retriever 810 may send the information about the M items to the dynamic aggregation engine 830, which can determine an aggregation level for each group product in the M items, e.g. based on the category of the group product and the user intent. In some embodiments, the dynamic aggregation engine 830 determines the aggregation level for each group product based on a machine learning model, e.g. the dynamic aggregation model 396 in the database 116. The dynamic aggregation model 396 may be trained periodically based on the model training data 350 including historical aggregation data and/or historical variant-level data. The determined aggregation levels may be stored in the historical aggregation data 352 for future model raining and/or data inference.

In some embodiments, the dynamic aggregation engine 830 can obtain or collect various data with respect to the search request 310, either from the pre-processing based item retriever 810 or directly from the database 116. In some embodiments, for each group product having variants, the aggregation level is determined to be one of: a high aggregation where all variants of the group product are aggregated into a single result when being displayed on a search result page; a low aggregation where each variant of the group product is displayed as a separate result on the search result page; or a medium aggregation where variants of the group product are aggregated into multiple sub-groups each of which is displayed as a separate result on the search result page.

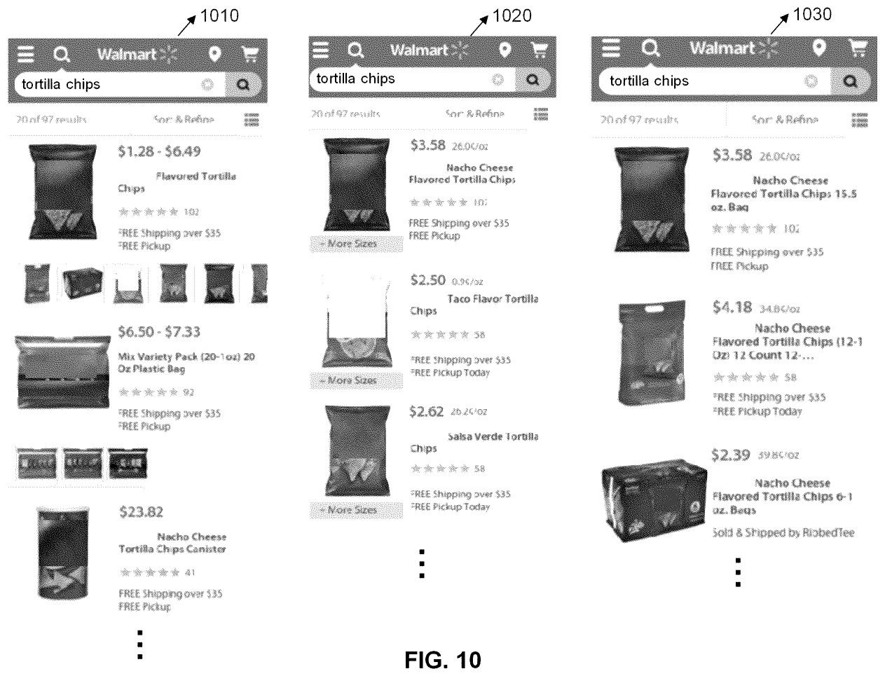

FIG. 10 illustrates exemplary aggregation levels in search results, in accordance with some embodiments of the present teaching. As shown in FIG. 10, in response to a query “tortilla chips,” a group product, including multiple variants of tortilla chips, can be fetched to be displayed in search results on a search result page. But there are different manners to display the multiple variants of tortilla chips.

In one example, all variants for a same product of tortilla chips are collapsed or aggregated into a single result on a first search result page 1010, which is called high aggregation. As shown in FIG. 10, on the first search result page 1010, different results are different products, e.g. different packs of tortilla chips. Each product, i.e. each pack of tortilla chips, can have different variants, referring to different flavors and different sizes. But all these variants of a same chip product are aggregated together as one single result, e.g. in a single tile, on the first search result page 1010. That is, a user needs to click on a specific chip product to view and select different flavors and/or different sizes of chips on a corresponding product page.

In another example, variants for a same product of tortilla chips are aggregated into multiple sub-groups, each displayed as a separate result, e.g. in a separate tile, on a second search result page 1020, which is called medium aggregation. As shown in FIG. 10, on the second search result page 1020, different results are different flavors of a same chip product. The chip product has different variants, each corresponding to a different flavor and a different size. While different flavors are displayed in different tiles respectively on the second search result page 1020, each flavor may have multiple sizes that are aggregated together. That is, while a user can directly see and select from different flavors on the second search result page 1020, the user needs to click on a specific flavor to view and select different sizes of chips on a corresponding product page. In general, medium aggregation may be applied when variants can be grouped according to multiple criteria. According to medium aggregation, the variants may be aggregated regarding one or more of the criteria, and disaggregated regarding the remaining criteria.

In yet another example, every variant of a same product of tortilla chips are disaggregated and displayed as a separate result, e.g. in a separate tile, on a third search result page 1030, which is called low aggregation. As shown in FIG. 10, on the third search result page 1030, different results are different flavors and sizes of a same chip product, where each flavor and size is displayed as a separate result in a separate tile. That is, a user can directly see and select from different flavors and different sizes on the third search result page 1030, without a need to click on a specific variant to go to a corresponding product page.

Referring back to FIG. 8, the dynamic aggregation engine 830 can select N items from the M items, based on their respective aggregation levels and their respective matching scores. As such, the dynamic aggregation engine 830 can send information about the N items, e.g. item IDs, matching scores, aggregation levels (for items that are variants of a group product), to the data and document fetching engine 840 for data fetching.

The data and document fetching engine 840 in this example can fetch documents and related metadata for each item (i.e. each variant or regular product) of the N items, from a database 845 storing document information for items associated with the website. The database 845 may be part of the database 116 or a standalone database. The data and document fetching engine 840 may send the fetched information for the N items to the ranking engine 850. In addition, the data and document fetching engine 840 may forward the information received from the dynamic aggregation engine 830 about the N items to the ranking engine 850.

The ranking engine 850 in this example may obtain the information about the N items from the data and document fetching engine 840, and generate a ranked list of the N items, e.g. based on a ranking service 855. While the ranking service 855 in FIG. 8 is outside the search-based recommendation computing device 102, the ranking service 855 may be included as part of the search-based recommendation computing device 102 in some embodiments. In some embodiments, the ranking service 855 can rank the N items based on their respective matching scores, historical search data and historical transaction data associated with the website. In some embodiments, the ranking service 855 can rank the N items using a ranking model, e.g. the ranking model 398 in the database 116, to generate the ranked list of the N items. In some embodiments, the ranking model may be a machine learning model trained based on variant level data including variant item level engagement and variant item title.

In some embodiments, the ranked list of N items includes at least two variants of a group product; and the at least two variants are to be displayed as separate results on the search result page based on at least one of: the aggregation level of the group product, historical data of the user associated with the website, or business logic data of the at least two variants.

In some embodiments, the post-processing based response generator 860 may generate the item recommendation 312 based on the ranked list of the N items. In some embodiments, the item recommendation 312 include the ranked list of the N items and position information for each item. In some examples, each of the ranked list of the N items has a corresponding rank and is recommended to be displayed at a corresponding position in a webpage based on its corresponding rank. For example, a higher ranked item may be recommended to be displayed at a more popular position in the webpage.

The post-processing based response generator 860 may transmit, in response to the search request 310, the item recommendation 312 to web server 104 in a data format (e.g., message) acceptable by the web server 104. The web server 104 may then update or generate item recommendation for presentation to the user 801 via a user device based on the item recommendation 312, which includes information about ranking and aggregation levels of recommended items. For example, the recommended items may be displayed on a webpage showing search results in response to a query to the user, based on the ranking determined by the ranking engine 850, and according to the aggregation levels determined by the dynamic aggregation engine 830.

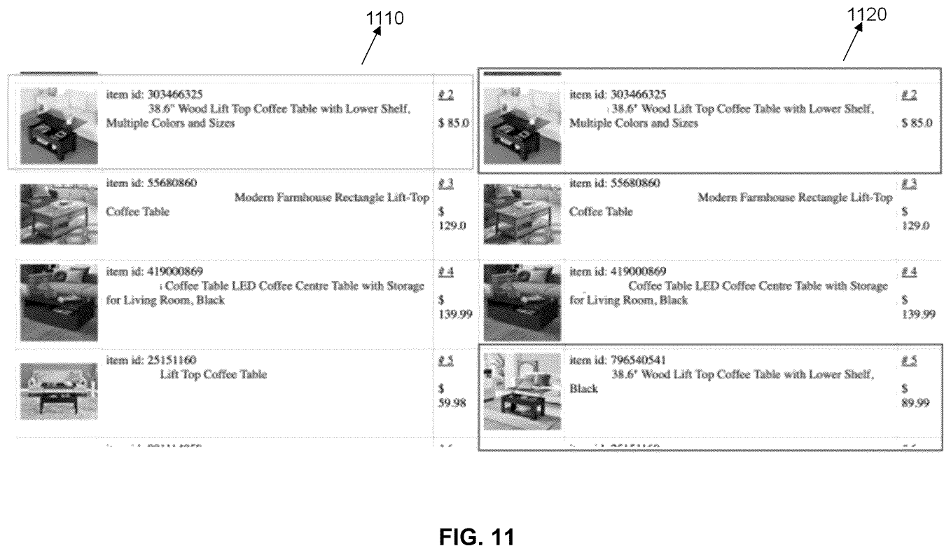

FIG. 11 illustrates a first user case of a search-based item recommendation system, e.g. the search-based item recommendation system described in FIGS. 1-10, in accordance with some embodiments of the present teaching. As shown in FIG. 11, in response to a query “coffee table,” different coffee tables can be displayed on a search result page. In one example, a search result page 1110 includes an item #2, which is a group leader of a group product having multiple variants of coffee tables. On the search result page 1110, only the group leader of the coffee table product group is shown. In contrast, on a search result page 1120, both the group leader (item #2) of the coffee table product group and a variant (item #5) of the same coffee table product group are displayed separately and simultaneously. In some embodiments, whether to disaggregate the variants of a product group on the search result page is dynamically determined by the system, as discussed above.

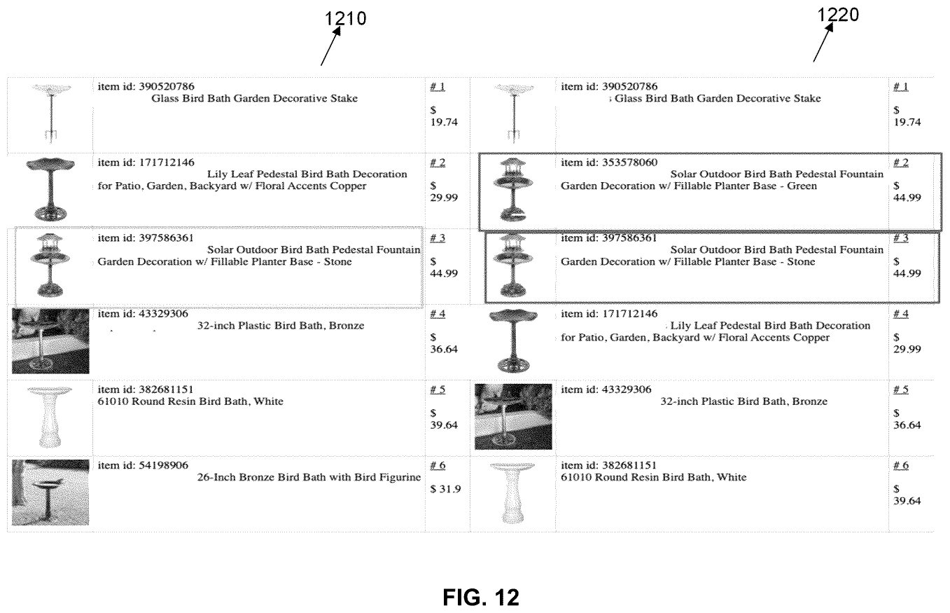

FIG. 12 illustrates a second user case of a search-based item recommendation system, e.g. the search-based item recommendation system described in FIGS. 1-10, in accordance with some embodiments of the present teaching. As shown in FIG. 12, in response to a query “bird bath,” different bird bath products can be displayed on a search result page. In one example, a search result page 1210 includes an item #3, which is a group leader of a group product having multiple variants of bird baths. On the search result page 1210, only the group leader of the bird bath product group is shown. In contrast, on a search result page 1220, both the group leader (item #3) of the bird bath product group and a variant (item #2) of the same bird bath product group are displayed separately and simultaneously. In some embodiments, whether to disaggregate the variants of a product group on the search result page is dynamically determined by the system, as discussed above.

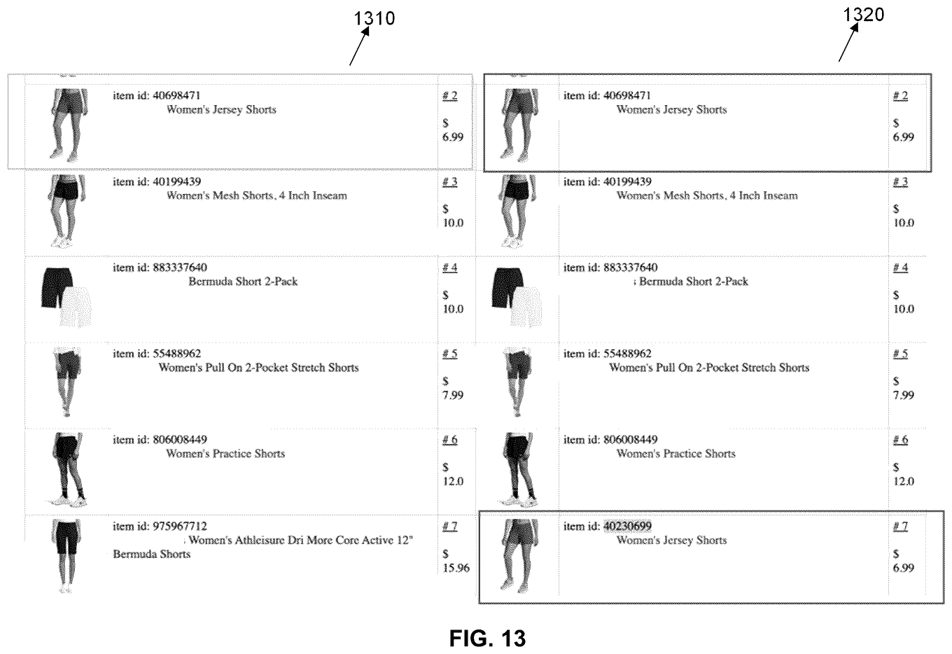

FIG. 13 illustrates a third user case of a search-based item recommendation system, e.g. the search-based item recommendation system described in FIGS. 1-10, in accordance with some embodiments of the present teaching. As shown in FIG. 13, in response to a query “women shorts,” different women shorts can be displayed on a search result page. In one example, a search result page 1310 includes an item #2, which is a group leader of a group product having multiple variants of women shorts. On the search result page 1310, only the group leader of the women shorts product group is shown. In contrast, on a search result page 1320, both the group leader (item #2) of the women shorts product group and a variant (item #7) of the same women shorts product group are displayed separately and simultaneously. In some embodiments, whether to disaggregate the variants of a product group on the search result page is dynamically determined by the system, as discussed above.

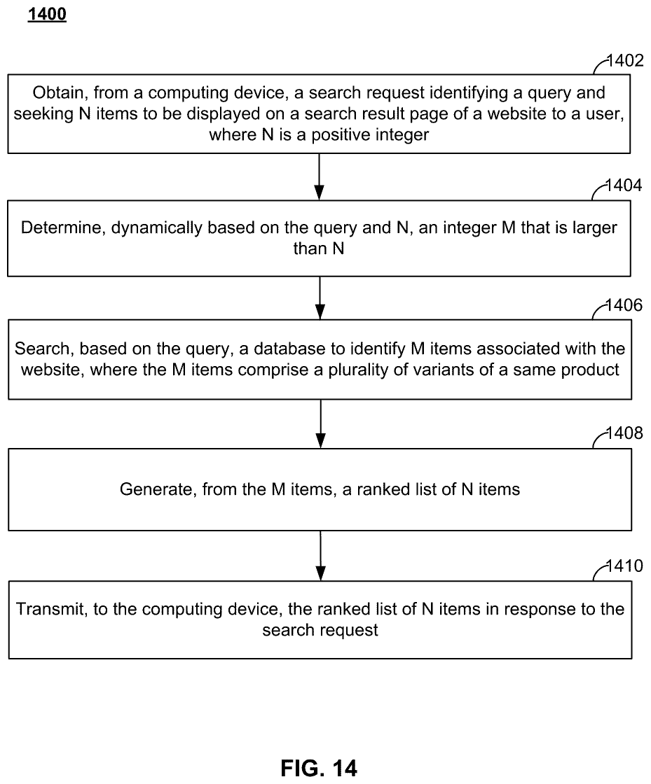

FIG. 14 is a flowchart illustrating an exemplary method 1400 for providing search results including dynamically disaggregated product variants, in accordance with some embodiments of the present teaching. In some embodiments, the method 1400 can be carried out by one or more computing devices, such as the search-based recommendation computing device 102 and/or the cloud-based engine 131 of FIG. 1. Beginning at operation 1402, a search request is obtained from a computing device, where the search request identifies a query and seeks N items to be displayed on a search result page of a website to a user, where N is a positive integer. At operation 1404, an integer M, which may be larger than N, is dynamically determined based on the query and N. At operation 1406, based on the query, a database is searched to identify M items associated with the website, where the M items comprise a plurality of variants of a same product. A ranked list of N items is generated at operation 1308 from the M items. At operation 1310, the ranked list of N items is transmitted to the computing device in response to the search request.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain, from a computing device, a search request identifying a query and seeking N items to be displayed on a search result page of a website to a user, wherein N is a positive integer,
determine, dynamically based on the query and N, an integer M,
search, based on the query, a database to identify M items associated with the website, wherein the M items comprise at least one subset of items that include at least one variant of a product,
generate, from the M items, a ranked list of N items, and
transmit, to the computing device, the ranked list of N items in response to the search request.

2. The system of claim 1, wherein:
the database includes group products each having a plurality of variants;
the database includes regular products without variants;
each variant in the database is indexed as an individual searchable item; and
each regular product in the database is indexed as an individual searchable item.

3. The system of claim 2, wherein the integer M is determined based on:
determining a category based on the query;
determining an intent of the user based on the query; and
determining, using a machine learning model, the integer M based on the category, the intent, and N.

4. The system of claim 3, wherein the machine learning model is trained periodically based on historical search data and historical transaction data associated with the website.

5. The system of claim 1, wherein the M items are identified based on:
for each variant in the database,
computing, based on historical data, a variant-level popularity score representing a popularity of the variant,
computing, based on the query, a variant-level relevance score representing a relevance of the variant to the query, and
computing a matching score for the variant based on the variant-level popularity score and the variant-level relevance score; and
identifying the M items based on their respective matching scores.

6. The system of claim 5, wherein the ranked list of N items is generated based on:
determining a category for each product in the M items;
determining an intent of the user based on the query;
determining, based on the category and the intent, an aggregation level for each product in the M items;
selecting, from the M items, N items based on their respective aggregation levels and their respective matching scores; and
ranking the N items to generate the ranked list of N items.

7. The system of claim 6, wherein:
the ranked list of N items are ranked, using a ranking model, based on their respective matching scores, historical search data and historical transaction data associated with the website.

8. The system of claim 6, wherein for each group product having variants, the aggregation level is determined to be one of:
a high aggregation where all variants of the group product are aggregated into a single result when being displayed on the search result page;
a low aggregation where each variant of the group product is displayed as a separate result on the search result page; or
a medium aggregation where variants of the group product are aggregated into multiple sub-groups each of which is displayed as a separate result on the search result page.

9. The system of claim 6, wherein:
the ranked list of N items includes at least two variants of a group product; and
the at least two variants are to be displayed as separate results on the search result page based on at least one of: the aggregation level of the group product, historical data of the user associated with the website, or business logic data of the at least two variants.

10. A computer-implemented method, comprising:
obtaining, from a computing device, a search request identifying a query and seeking N items to be displayed on a search result page of a website to a user, wherein N is a positive integer;
determining, dynamically based on the query and N, an integer M;
searching, based on the query, a database to identify M items associated with the website, wherein the M items comprise at least one subset of items that include at least one variant of a product;
generating, from the M items, a ranked list of N items; and
transmitting, to the computing device, the ranked list of N items in response to the search request.

11. The computer-implemented method of claim 10, wherein:
the database includes group products each having a plurality of variants;
the database includes regular products without variants;
each variant in the database is indexed as an individual searchable item; and
each regular product in the database is indexed as an individual searchable item.

12. The computer-implemented method of claim 11, wherein determining the integer M comprises:
determining a category based on the query;
determining an intent of the user based on the query; and
determining, using a machine learning model, the integer M based on the category, the intent, and N.

13. The computer-implemented method of claim 12, wherein the machine learning model is trained periodically based on historical search data and historical transaction data associated with the website.

14. The computer-implemented method of claim 10, wherein searching the database comprises:
for each variant in the database,
computing, based on historical data, a variant-level popularity score representing a popularity of the variant,
computing, based on the query, a variant-level relevance score representing a relevance of the variant to the query, and
computing a matching score for the variant based on the variant-level popularity score and the variant-level relevance score; and
identifying the M items based on their respective matching scores.

15. The computer-implemented method of claim 14, wherein generating the ranked list of N items comprises:
determining a category for each product in the M items;
determining an intent of the user based on the query;
determining, based on the category and the intent, an aggregation level for each product in the M items;
selecting, from the M items, N items based on their respective aggregation levels and their respective matching scores; and
ranking the N items to generate the ranked list of N items.

16. The computer-implemented method of claim 15, wherein:
the ranked list of N items are ranked, using a ranking model, based on their respective matching scores, historical search data and historical transaction data associated with the website.

17. The computer-implemented method of claim 15, wherein for each group product having variants, the aggregation level is determined to be one of:
a high aggregation where all variants of the group product are aggregated into a single result when being displayed on the search result page;
a low aggregation where each variant of the group product is displayed as a separate result on the search result page; or
a medium aggregation where variants of the group product are aggregated into multiple sub-groups each of which is displayed as a separate result on the search result page.

18. The computer-implemented method of claim 15, wherein:
the ranked list of N items includes at least two variants of a group product; and
the at least two variants are to be displayed as separate results on the search result page based on at least one of: the aggregation level of the group product, historical data of the user associated with the website, or business logic data of the at least two variants.

19. A non-transitory computer readable medium having instructions stored thereon, wherein the instructions, when executed by at least one processor, cause at least one device to perform operations comprising:
obtaining, from a computing device, a search request identifying a query and seeking N items to be displayed on a search result page of a website to a user, wherein N is a positive integer;
determining, dynamically based on the query and N, an integer M;
searching, based on the query, a database to identify M items associated with the website, wherein the M items comprise at least one subset of items that include at least one variant of a product;
generating, from the M items, a ranked list of N items; and
transmitting, to the computing device, the ranked list of N items in response to the search request.

20. The non-transitory computer readable medium of claim 19, wherein searching the database comprises:
for each variant in the database,
computing, based on historical data, a variant-level popularity score representing a popularity of the variant,
computing, based on the query, a variant-level relevance score representing a relevance of the variant to the query, and
computing a matching score for the variant based on the variant-level popularity score and the variant-level relevance score; and
identifying the M items based on their respective matching scores.
